(19) United States
(12) Patent Application Publication
(10) Pub. No.: US 2026/0091877 A1
(43) Pub. Date: Apr. 2, 2026

(54) AIRCRAFT PROPULSION ASSEMBLY INCLUDING A SUPPORTING STRUCTURE BETWEEN AN ENGINE ASSEMBLY AND A PRIMARY STRUCTURE OF A PYLON

(71) Applicant: Airbus Operations SAS, TOULOUSE (FR)

(72) Inventors: Rémi LANSIAUX, TOULOUSE (FR); Nicolas CHARTON, TOULOUSE (FR); Jean-Baptiste VIGNES, TOULOUSE (FR); Mohammed-Amine BENNAIEM, TOULOUSE (FR); Julien VINOT, TOULOUSE (FR); Xavier CARCENAC, TOULOUSE (FR)

(21) Appl. No.: 19/341,263

(22) Filed: Sep. 26, 2025

(30) Foreign Application Priority Data
Sep. 30, 2024 (FR) FR2410478

(51) Int. Cl. B64D 27/40

(52) U.S. Cl. CPC B64D 27/402

(57) ABSTRACT

An aircraft propulsion assembly including an engine assembly that includes front and rear parts offset along a longitudinal axis, a primary structure of a pylon, at least one supporting structure that extends along the longitudinal axis, separate from the rear part and connected to the front part of the engine assembly, an engine-attachment system that includes at least one front attachment directly connecting the engine assembly and the primary structure, and at least one rear attachment offset toward the rear relative to the front attachment connecting the primary structure and the supporting structure.

### CROSS-REFERENCES TO RELATED APPLICATIONS

This application claims the benefit of French Patent Application Number FR2410478 filed on Sep. 30, 2024, the entire disclosures of which are incorporated herein by way of reference.

### FIELD OF THE INVENTION

The present application relates to an aircraft propulsion assembly including a supporting structure between an engine assembly and a primary structure of a pylon.

### BACKGROUND OF THE INVENTION

In a configuration that can be seen in FIGS. 1 to 3 an aircraft 10 includes a plurality of propulsion assemblies 12 that are positioned under the wings 14 of the aircraft

A propulsion assembly 12 includes an engine assembly 16, a nacelle (not represented in FIGS. 2 and 3) positioned around the engine assembly 16 and a pylon 18 connecting the engine assembly 16 to the rest of aircraft 10, in particular, to the wings 14.

In the remainder of the description a longitudinal axis X is parallel to the rotation axis A16 of the engine assembly 16. A transverse plane is a plane perpendicular to the rotation axis A16 of the engine assembly 16. A longitudinal plane is a plane passing through the rotation axis A16 of the engine assembly 16. A transverse and horizontal direction Y is a horizontal direction perpendicular to the rotation axis A16 of the engine assembly 16. A transverse and vertical direction Z is a vertical direction perpendicular to the rotation axis A16 of the engine assembly 16. A median vertical plane PMV is a vertical plane containing the rotation axis A16 of the engine assembly 16. A median horizontal plane is a horizontal plane containing the rotation axis A16 of the engine assembly 16. The terms front and rear refer to the direction of flow of the flow of air in the engine assembly 16, flowing from the front to the rear.

The engine assembly 16 includes a fan 20 that includes a fan fairing 20.1 and an engine core 22 that has a front part 22.1 positioned inside the fan 20, a central part 22.2 and a rear part 22.3 incorporating, in particular, a jet pipe. In one configuration, the central part 22.2 has a cross section less than that of the front and rear parts 22.1, 22.3. The engine core 22 has an exterior envelope called the engine assembly fairing F22.

The pylon 18 includes a primary structure 24 in the form of a box that is connected to the wings 14 by a wing-attachment system 26 and to the engine assembly 16 by an engine-attachment system 28. This primary structure 24 has a front end 24.1, a median part 24.2 and a rear end 24.3.

In a first embodiment that can be seen in FIG. 2 the engine-attachment system 28 includes a front attachment 28.1 connecting the front end 24.1 of the primary structure 24 and the front and/or central part 22.1, 22.2 of the engine core 22, a rear attachment 28.2 connecting the rear end 24.3 of the primary structure 24 and the rear part 22.3 of the engine core 22, and two links 28.3 positioned symmetrically with respect to the median vertical plane PMV of the engine assembly 16, connecting the primary structure 24 and the front and/or central part 22.1, 22.2 of the engine core 22.

In a second embodiment that can be seen in FIG. 3, the engine-attachment system 28 includes a front attachment 28.1 connecting the front end 24.1 of the primary structure 24 and the fan fairing 20.1 of the fan 20, a rear attachment 28.2 connecting the rear end 24.3 of the primary structure 24 and the rear part 22.3 of the engine core 22, and two links 28.3 positioned symmetrically with respect to the median vertical plane PMV of the engine assembly 16, connecting the primary structure 24 and the front and/or central part 22.1, 22.2 of the engine core 22.

In some circumstances these two embodiments do not enable optimum transfer of forces between the engine assembly 16 and the primary structure 24 of the pylon 18.

The present invention aims to remedy some or all of the disadvantages of the prior art.

### SUMMARY OF THE INVENTION

To this end, the invention has for an object an aircraft propulsion assembly including:
a. an engine assembly that extends from front to rear along a longitudinal axis and includes, at the front, a front part and, at the rear of the front part, a rear part corresponding to a part of an engine core, the front and rear parts each having a circumferential shape, the front part having a section greater than that of the rear part,
b. a primary structure of a pylon, and
c. an engine-attachment system connecting the primary structure and the front part of the engine assembly, the engine-attachment system including at least one front attachment directly connecting the engine assembly and the primary structure.

According to the invention, the propulsion assembly includes at least one supporting structure extending along an axis parallel to the longitudinal axis and at least a part of the circumference of the rear part of the engine assembly, the supporting structure being separate from the rear part of the engine assembly, distant from the engine core and connected to the front part of the engine assembly, the engine-attachment including at least one rear attachment offset toward the rear relative to the front attachment connecting the primary structure and the supporting structure.

This solution enables optimization of the transfer of forces between the engine assembly and the primary structure of the pylon, the forces being absorbed at the level of the same part of the engine assembly.

According to one feature, the supporting structure is an openwork structure.

According to another feature, the supporting structure is of substantially tubular shape.

According to another feature, the front attachment and the supporting structure are connected to the engine assembly approximately in the same transverse attachment plane.

According to another feature, the supporting structure is a lattice structure and includes longitudinal reinforcements and/or at least one transverse reinforcement interconnected in such a manner as to form quadrilateral or triangular meshes.

According to another feature, the supporting structure extends between front and rear ends, the front end being connected to the engine assembly, the supporting structure including at least one transverse reinforcement at the rear end.

According to another feature, the supporting structure includes at least one intermediate transverse reinforcement between the front and rear ends.

According to another feature, the rear attachment includes:
a. transverse beam rigidly attached to the primary structure,
b. at least one first, two-point link, positioned on a first side of a median vertical plane and connected to the transverse beam by a first pivot pin and to the supporting structure by a second pivot pin, and
c. at least one second, three-point link positioned on a second side of the median vertical plane and connected to the transverse beam by third and fourth pivot pins and to the supporting structure by a fifth pivot pin.

According to another feature, the engine-attachment system includes at least one fail-safe type safety connection connecting the primary structure and the supporting structure or the rear part of the engine assembly configured not to form a path for forces when the rear attachment is operational and to form a path for forces if the rear attachment is damaged.

According to another feature, the engine-attachment system includes at least one link that has a first end connected to the supporting structure and a second end connected to the engine assembly.

According to another feature, the engine-attachment system includes a plurality of links symmetrically positioned with respect to a median vertical plane and/or with respect to a median horizonal plane.

### BRIEF DESCRIPTION OF THE DRAWINGS

Other features and advantages will emerge from the following description of the invention given by way of example only with reference to the appended drawings, in which:

FIG. 1 is a perspective view of an aircraft,

FIG. 2 is a schematic lateral representation of an aircraft propulsion assembly (without the nacelle) depicting a first embodiment of the prior art,

FIG. 3 is a schematic lateral representation of an aircraft propulsion assembly (without the nacelle) depicting a second embodiment of the prior art,

FIG. 4 is a schematic lateral representation of an aircraft propulsion assembly (without the nacelle) depicting one embodiment of the invention,

FIG. 5 is a schematic cross section of an aircraft propulsion assembly depicting one embodiment of the invention,

FIG. 6 is a schematic cross section of an aircraft propulsion assembly depicting another embodiment of the invention,

FIG. 7 is a rear view of an aircraft propulsion assembly (without the nacelle) depicting one embodiment of the invention,

FIG. 8 is a rear view of a part of an engine-attachment system of the propulsion assembly that can be seen in FIG. 7,

FIG. 9 is a schematic lateral representation of an aircraft propulsion assembly including an openwork supporting structure depicting a first embodiment of the invention,

FIG. 10 is a schematic lateral representation of an aircraft propulsion assembly including an openwork supporting structure depicting a second embodiment of the invention,

FIG. 11 is a schematic lateral representation of an aircraft propulsion assembly including an openwork supporting structure depicting a third embodiment of the invention,

FIG. 12 is a rear view of a propulsion assembly including an openwork supporting structure depicting one embodiment of the invention,

FIG. 13 is a perspective view of a propulsion assembly (without the nacelle) depicting one embodiment of the invention,

FIG. 14 is a perspective view of a part of an engine-attachment system of the propulsion assembly that can be seen in FIG. 13.

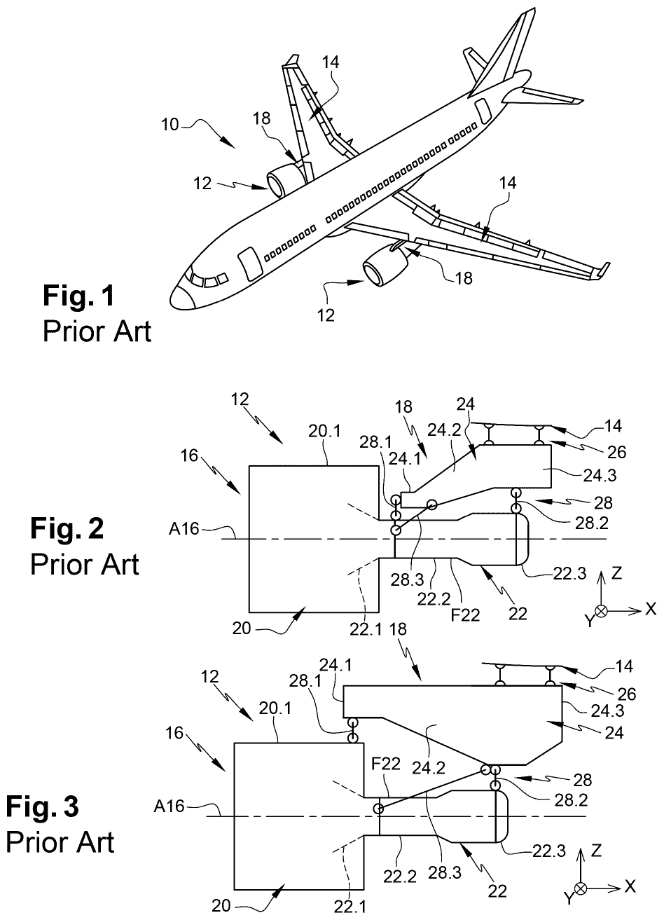

### DETAILED DESCRIPTION OF THE PREFERRED EMBODIMENTS

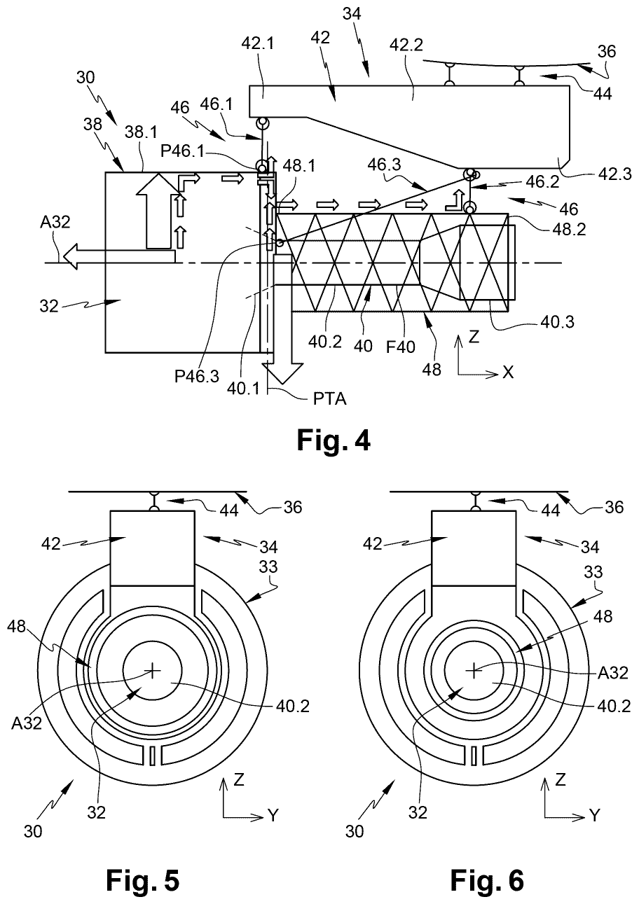

In an embodiment that can be seen in FIGS. 4 to 14, a propulsion assembly 30 includes an engine assembly 32 extending from front to rear along a longitudinal axis X and having a rotation axis A32 parallel to the longitudinal axis X, a nacelle 33 (seen in FIGS. 5 and 6) positioned around the engine assembly 32 and a pylon 34 configured to connect the propulsion assembly 30 and, more particularly, the engine assembly 32 to the wings 36 of an aircraft. The latter includes at least one such propulsion assembly 30.

In one configuration, the engine assembly 32 includes a fan 38 and an engine core 40.

The fan 38 includes a fan fairing 38.1. The engine core 40 includes, from the front to the rear, a front part 40.1 positioned inside the fan 38, a central part 40.2 and a rear part 40.3 incorporating, in particular, high-pressure and low-pressure turbines and a jet pipe. In one configuration, the central part 40.2 has a cross section less than those of the front and rear parts 40.1, 40.3. The engine core 40 has an exterior envelope called the engine assembly fairing F40.

The nacelle 33 has an interior surface oriented towards the engine assembly 32 which delimits with the engine assembly fairing F40 of the engine core 40 an annular duct in which a so-called secondary air flow coming from the fan 38 flows during operation.

The pylon 34 includes a primary structure 42 in the form of a box that is connected to the wings 36 by a wing-attachment system 44 and to the engine assembly 32 by an engine-attachment system 46. This primary structure 42 has a front end 42.1, a median part 42.2 and a rear end 42.3.

The engine-attachment system 46 includes at least one front attachment 46.1 directly connecting the primary structure 42 of the pylon and the engine assembly 32 (the fan 38 and/or the front part 40.1 of the engine core 40). In a preferred embodiment, the front attachment 46.1 connects the fan fairing 38.1 of the fan 38 and the front end 42.1 of the primary structure 42. This front attachment 46.1 is configured to absorb thrust forces. In another configuration, the front attachment 46.1 is identical to that of the prior art.

In accordance with one particular feature of the invention, the propulsion assembly 30 includes at least one supporting structure 48 that extends between front and rear ends 48.1, 48.2 oriented along an axis parallel to the longitudinal axis X, the front end 48.1 being connected to the engine assembly 32. In a preferred embodiment the supporting structure 48, to be more specific its front end 48.1, is connected to the fan 38 and more particularly to the fan fairing 38.1.

The supporting structure 48 is separate from the primary structure 42 of the pylon and the exterior envelope (or engine assembly fairing) F40 of the engine core 40. This supporting structure 48 is spaced from the exterior envelope (or engine assembly fairing) F40 of the engine core 40, as well as from the interior surface of the nacelle 33. Thus, in operation, the supporting structure 48 is located in the secondary air flow so that a first part of this secondary air flow flows between the supporting structure 48 and the interior surface of the nacelle 33 and a second part of this secondary air flow flows between the supporting structure 48 and the exterior envelope (or engine assembly fairing) F40 of the engine core 40.

According to one embodiment, the supporting structure 48 is an openwork structure. By openwork is meant that the supporting structure has an open factor (corresponding to the ratio of the sum of the open areas to the total area) of at least 50%. Furthermore, in contrast to the exterior envelope F40 of the engine core 40, it has sufficient stiffness to form a path for forces between the engine assembly 32 and the primary structure 42.

The engine-attachment system 46 includes at least one rear attachment 46.2 offset toward the rear relative to the front attachment 46.1 and connecting the primary structure 42 and the supporting structure 48. In one arrangement, the rear attachment 46.2 connects the median part 42.2 and/or the rear end 42.3 of the primary structure 42 and the rear end 48.2 of the supporting structure 48 or a zone in the vicinity of that rear end 48.2.

In one embodiment, the engine-attachment system 46 includes two links 46.3 symmetrically positioned with respect to a median vertical plane PMV of the engine assembly 32 and connecting the primary structure 42 and the front and/or central part 40.1, 40.2 of the engine core 40.

In one arrangement, the front attachment 46.1 and the links 46.3 are connected to the engine assembly 32 at anchor points P46.1, P46.3 positioned in approximately the same transverse attachment plane PTA.

In one embodiment, the engine-attachment system 46 includes at least one front attachment 46.1 directly connecting the engine assembly 32 and the primary structure 42, the front attachment 46.1 being connected to the engine assembly 32 at the level of a transverse attachment plane PTA, the supporting structure being also connected to the engine assembly 32 at approximately the level of the transverse attachment plane PTA.

The supporting structure 48 is, over at least a part of the circumference of the engine assembly 32 and preferably all the circumference, spaced from the engine core 40 and positioned between the engine core 40 and the nacelle 33.

In a first configuration, the openwork supporting structure 48 is a beam that does not extend around the engine core 40.

In a second configuration, the supporting structure 48 extends over at least a part of the circumference of the engine core 40. The supporting structure 48 is tubular and extends all around the engine core 40. The supporting structure is at a distance from the engine core 40.

In a first embodiment that can be seen in FIG. 4, the supporting structure 48 is cylindrical.

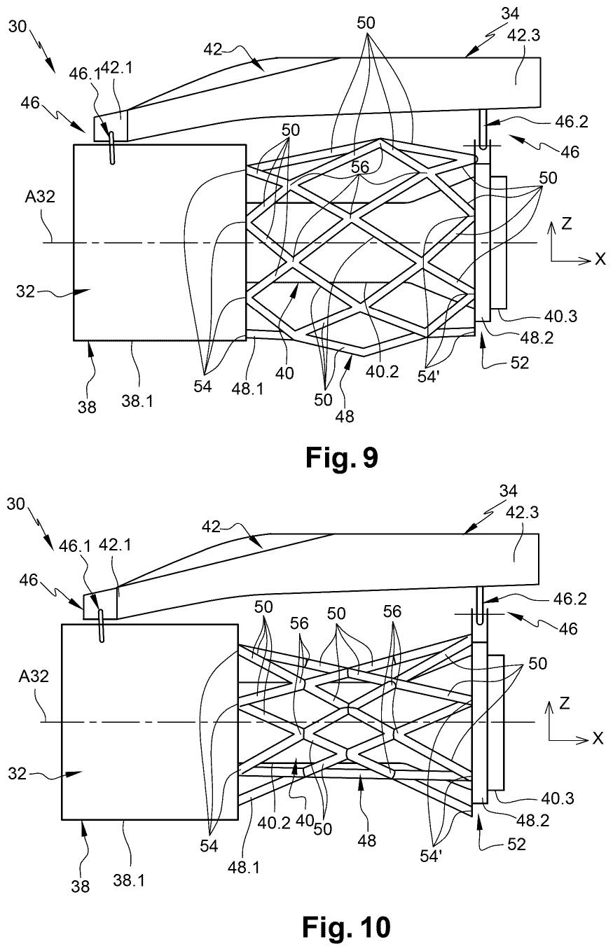

In a second embodiment that can be seen in FIG. 9, the supporting structure 48 is barrel-shaped.

In a third embodiment that can be seen in FIG. 10, the supporting structure 48 has a hyperbolic shape.

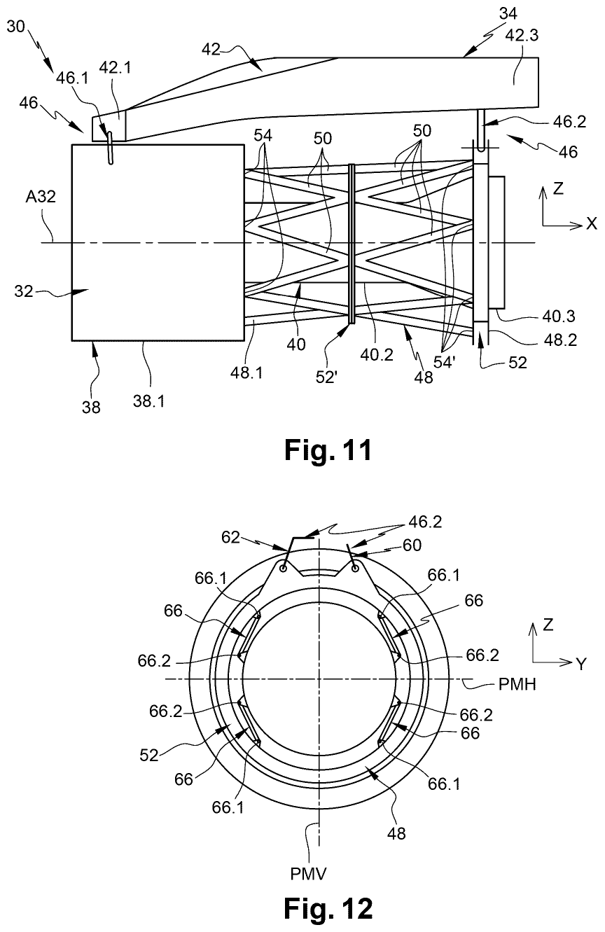

In a fourth embodiment that can be seen in FIG. 11, the supporting structure 48 is frustoconical.

Of course the invention is not limited to these geometries of the supporting structure 48.

In a configuration that can be seen in FIG. 5, the supporting structure 48 is closer to the nacelle 33 than the engine core 40 in at least one transverse plane.

In another configuration that can be seen in FIG. 6, the supporting structure 48 is closer to the engine core 40 than the nacelle 33 in at least one transverse plane.

In one embodiment, the supporting structure 48 is a lattice structure and includes a plurality of longitudinal reinforcements 50 and at least one transverse reinforcement 52. The supporting structure 48 can include at least one longitudinal reinforcement that extends from its front end 48.1 to its rear end 48.2.

In one configuration, each lengthwise reinforcement 50 is rectilinear and has a circular section. Of course the invention is not limited to this section of the lengthwise reinforcements 50.

Some lengthwise reinforcements 50 are directly connected to the engine assembly 32, in each case by a connecting system 54 including, for example, at least one element such as a pin, a rivet, a bolt or any other connecting element.

Some lengthwise reinforcements 50 are directly connected to a transverse reinforcement 52, in each case by a connecting system 54′ including, for example, at least one element such as a pin, a rivet, a bolt or any other connecting element.

In one embodiment that can be seen, for example, in FIGS. 9, 10 and 13 the lattice supporting structure 48 includes a single rear transverse reinforcement 52 at its rear end 48.2.

In another embodiment that can be seen in FIG. 11, the lattice supporting structure 48 includes a rear transverse reinforcement 52 at the rear end 48.2 and at least one intermediate transverse reinforcement 52′ between the front and rear ends 48.1, 48.2 of the lattice supporting structure 48.

The lattice supporting structure 48 could include a front transverse reinforcement at the front end 48.1 of the lattice supporting structure 48 and directly connected to the engine assembly.

In embodiments that can be seen in FIGS. 9, 10 and 13, the lengthwise reinforcements 50 are interconnected at the level of nodes 56 in such a manner as to form quadrilateral meshes. In these embodiments the lengthwise reinforcements 50 connected to the transverse reinforcement 52 or to the engine assembly 32 form with the latter triangular meshes.

In another embodiment that can be seen in FIG. 11, the lengthwise reinforcements 50, the transverse reinforcements 52, 52′ and the engine assembly 32 are interconnected in such a manner as to form triangular meshes.

Of course the invention is not limited to these geometries of the meshes. The lattice supporting structure 48 generally includes lengthwise reinforcements 50 and/or at least one transverse reinforcement 52 interconnected in such a manner as to form quadrilateral or triangular meshes in order to obtain an openwork structure.

The longitudinal and transverse reinforcements 50, 52, 52′ can be made of metal and/or composite material.

In one embodiment, at least one transverse reinforcement 52, 52′ includes at least one plate positioned in a transverse plane. In one arrangement at least one transverse reinforcement 52 includes two closely spaced and interconnected parallel plates.

In one configuration, at least one transverse reinforcement 52, 52′ extends continuously over all the circumference of the engine core 40 and forms a ring. In another configuration, at least one transverse reinforcement 52, 52′ forms a U shape that has ends oriented toward the primary structure 42 or toward the engine assembly 32.

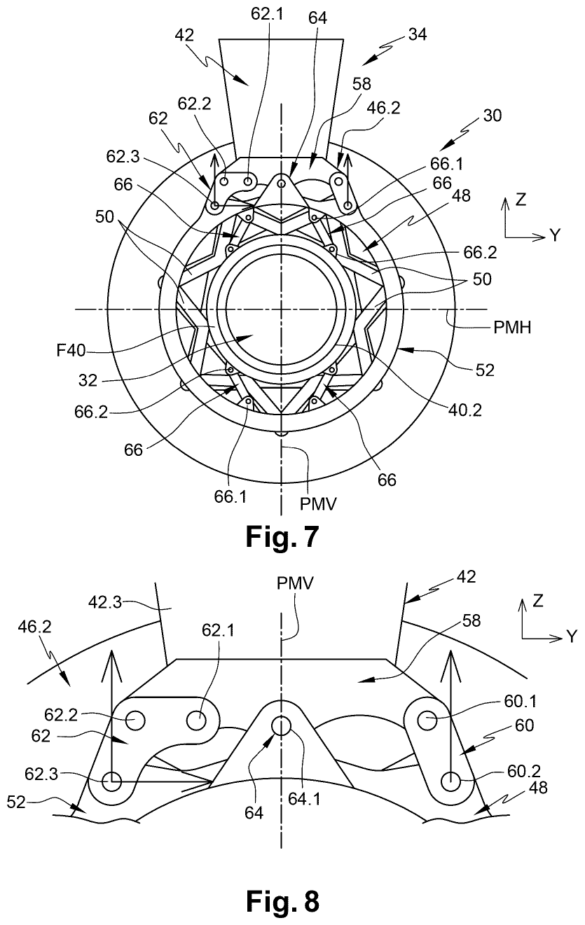

In an embodiment, details of which can be seen in FIGS. 7 and 8, the rear attachment 46.2 connecting the supporting structure 48 and the primary structure 42 is configured to absorb forces in horizontal and vertical transverse directions Y, Z and torque around the rotation axis A32 of the engine assembly 32. It includes:
a. a transverse beam 58 rigidly attached to the primary structure 42,
b. at least one first, two-point link 60 positioned on a first side of the median vertical plane PMV and connected to the transverse beam 58 by a first pivot pin 60.1 and to the supporting structure 48 by a second pivot pin 60.2, and
c. at least one second, three-point link 62 positioned on a second side of the median vertical plane PMV and connected to the transverse beam 58 by third and fourth pivot pins 62.1, 62.2 and to the supporting structure 48 by a fifth pivot pin 62.3.

The various pivot pins 60.1, 60.2, 62.1, 62.2, 62.3 are substantially parallel to one another and to the longitudinal axis X.

In this embodiment, the first, two-point link 60 is configured to transfer forces along a substantially vertical axis. Complementing this, the second, three-point link 62 is configured to transfer forces along the horizontal and vertical axes Y, Z. The first and second links 60, 62 enable absorption of torsion forces about the longitudinal axis X.

In one embodiment, the engine-attachment system 46 includes at least one fail-safe type safety connection 64, 64′ connecting the primary structure 42 and the openwork support structure 48 or the engine assembly 32, in particular the engine core 40, configured so as not to form a path for forces when the rear attachment 46.2 is operational and functioning correctly and to form a path for forces in the event of the rear attachment 46.2 being damaged.

In an arrangement that can be seen in FIGS. 7 and 8, the fail-safe type safety connection 64 connects the transverse beam 58 and the supporting structure 48, in particular the rear end 48.2 of the supporting structure 48.

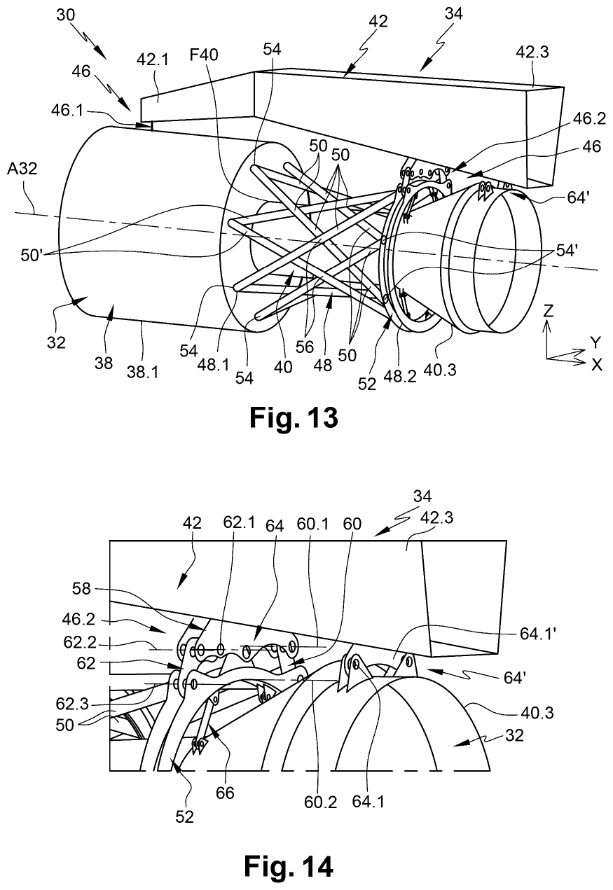

In another arrangement that can be seen in FIGS. 13 and 14, the fail-safe type safety connection 64′ connects the primary structure 42 and the engine core 40, in particular the rear part 40.3 of the engine core 40.

In one embodiment, the fail-safe type safety connection 64, 64′ includes at least one pin 64.1 substantially parallel to the longitudinal axis X.

In an arrangement that can be seen in FIG. 8, the fail-safe type safety connection 64 includes a single pin 64.1 positioned at the level of the median vertical plane PMV.

In an arrangement that be seen in FIG. 14, the fail-safe type safety connection 64′ includes two safety pins 64.1, 64.1′ positioned symmetrically with respect to the median vertical plane PMV.

In an embodiment that can be seen in FIGS. 7 and 12, the engine-attachment system 46 comprises at least one link 66 that has a first end 66.1 connected to the supporting structure 48, more specifically to the rear transverse reinforcement 52, and a second end 66.2 connected to the engine assembly 32, more specifically to the rear part 40.3 of the engine core 40.

In one configuration, the first end 66.1 of the link 66 is connected to the supporting structure 48 by an articulation that includes at least one pivot pin parallel to the longitudinal axis. Complementing this, the second end 66.2 of the link 66 is connected to the engine core 40 by an articulation that includes at least one pivot pin parallel to the longitudinal axis X.

In one arrangement, the engine-attachment system 46 includes a plurality of links 66 positioned symmetrically with respect to the median vertical plane PMV.

In an embodiment that can be seen in FIG. 12, the engine-attachment system 46 includes a plurality of links 66 positioned symmetrically with respect to a median horizontal plane PMH.

The link(s) 66 enable support of the engine core 40 and some of the weight of the engine core 40. It or they also enable limitation of radial movements of the engine core 40.

In any embodiment, the supporting structure 48, which is separate from the rear part of the engine assembly 32, enables transfer of forces between the engine assembly 32 and the primary structure 42 of the pylon, the forces being absorbed at the level of the same part of the engine assembly 32, namely the fan fairing 38.1.

This configuration enables optimization of the transfer of forces between the engine assembly 32 and the primary structure 42 of the pylon. The supporting structure 48 is a widely open openwork structure and allows easy access to the engine core 40. Finally, for constant mass, providing an openwork supporting structure enables a rigid structure to be obtained that has a high stiffness in all directions.

Of course, the invention is not limited to engine assemblies that include a fan positioned in a fan fairing. Thus, it can apply to any engine assembly that extends from front to rear along a longitudinal axis and includes a front part and a rear part connected to the front part and offset toward the rear along the longitudinal axis relative to the front part. The rear part can be a part of the engine core of a turbojet or a turboprop engine. Depending on the application, the front part can be a fan fairing 38.1 in the case of a ducted fan. The front part can also be a supporting structure on which is mounted an unshrouded fan or an unshrouded propeller or any other structure of an engine assembly 32 positioned at the front of the latter and configured to form a path for thrust forces generated during use of the engine assembly 32. Each of the front and rear parts has a circumferential shape and the front part of the engine assembly 32 has a section greater than that of the rear part.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Moreover, throughout this document including the claims, expressions such as “at least one of”, or “one or more of”, when preceding a list of elements, modify the entire list of elements and do not modify the individual elements of the list.

1. An aircraft propulsion assembly comprising:
an engine assembly that extends from front to rear along a longitudinal axis and includes at a front a front part and at a rear of the front part a rear part corresponding to a part of an engine core, the front and rear parts each having a circumferential shape, the front part having a section larger than that of the rear part,
a primary structure of a pylon,
an engine-attachment system connecting the primary structure and the front part of the engine assembly, the engine-attachment system including at least one front attachment directly connecting the engine assembly and the primary structure;
at least one supporting structure extending along an axis parallel to the longitudinal axis and at least a part of a circumference of the rear part of the engine assembly, said supporting structure being separate from the rear part of the engine assembly, distant from the engine core and connected to the front part of the engine assembly, and
the engine-attachment system comprising at least one rear attachment offset rearwardly relative to the front attachment and connecting the primary structure and the least one supporting structure.

2. The propulsion assembly according to claim 1, wherein the supporting structure is an openwork structure.

3. The propulsion assembly according to claim 1, wherein the supporting structure is of substantially tubular shape.

4. The propulsion assembly according to claim 1, wherein the front attachment and the supporting structure are connected to the engine assembly in approximately a common transverse attachment plane.

5. The propulsion assembly according to claim 1, wherein the supporting structure is a lattice structure and includes one or more of longitudinal reinforcements or at least one transverse reinforcement, interconnected in such a manner as to form quadrilateral or triangular meshes.

6. The propulsion assembly according to claim 5, wherein the supporting structure extends between front and rear ends, the front end being connected to the engine assembly and the supporting structure including at least one transverse reinforcement at the rear end.

7. The propulsion assembly according to claim 6, wherein the supporting structure includes at least one intermediate transverse reinforcement between the front and rear ends.

8. The propulsion assembly according to claim 1, wherein the at least one rear attachment includes:
a transverse beam rigidly attached to the primary structure,
at least one first, two-point link, positioned on a first side of a median vertical plane and connected to the transverse beam by a first pivot pin and to the supporting structure by a second pivot pin, and
at least one second, three-point link positioned on a second side of the median vertical plane and connected to the transverse beam by third and fourth pivot pins and to the supporting structure by a fifth pivot pin.

9. The propulsion assembly according to claim 1, wherein the engine-attachment system includes at least one fail-safe type safety connection connecting the primary structure and the supporting structure or the rear part of the engine assembly, configured not to form a path for forces when the rear attachment is operational and to form a path for forces if the at least one rear attachment is damaged.

10. The propulsion assembly according to claim 1, wherein the engine-attachment system includes at least one link that has a first end connected to the supporting structure and a second end connected to the engine assembly.

11. The propulsion assembly according to claim 10, wherein the engine-attachment system includes a plurality of links symmetrically positioned with respect to one or more of a median vertical plane or a median horizonal plane.
